(19) United States
(12) Patent Application Publication
(10) Pub. No.: US 2026/0113303 A1
(43) Pub. Date: Apr. 23, 2026

(54) Operation of an IoT Device Having Applications

(71) Applicant: Siemens Aktiengesellschaft, München (DE)

(72) Inventors: Rainer Falk, München (DE); Steffen Fries, München (DE); Thomas Schreck, München (DE)

(73) Assignee: Siemens Aktiengesellschaft, München (DE)

(21) Appl. No.: 19/475,593

(22) PCT Filed: Mar. 22, 2024
(86) PCT No.: PCT/EP2024/057717

§ 371 Date: Oct. 15, 2025

(30) Foreign Application Priority Data
Apr. 18, 2023 (EP) 23168463.0
Sep. 11, 2023 (EP) 23196572.4

(51) Int. Cl. H04L 9/40

(52) U.S. Cl. CPC H04L 63/0245

(57) ABSTRACT

Various embodiments include a method for operating an IoT device having one or more applications which process messages according to application protocols. An example includes: receiving messages for the application protocols at the IoT device; sampling a device integrity status of the IoT device; filtering the messages for the application protocols on the basis of the device integrity status; and, after filtering the messages, processing the messages by the applications according to the application protocols.

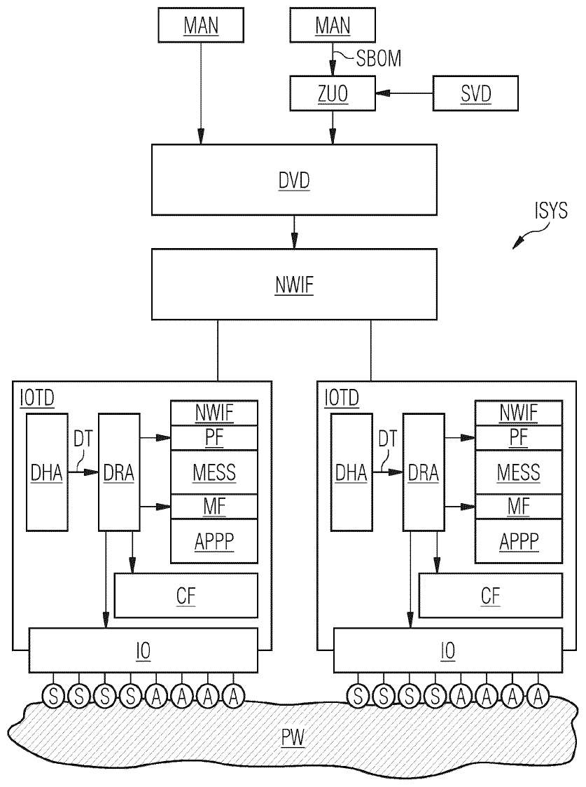

### CROSS-REFERENCE TO RELATED APPLICATIONS

This application is a U.S. National Stage Application of International Application No. PCT/EP2024/057717 filed Mar. 22, 2024, which designates the United States of America, and claims priority to EP Application No. 23196572.4 filed Sep. 11, 2023, and EP Application No. 23168463.0 filed Apr. 18, 2023, the contents of which are hereby incorporated by reference in their entirety.

### TECHNICAL FIELD

The present disclosure relates to IoT devices. Various embodiments of the teachings herein include methods and systems for operating IoT devices having applications.

### BACKGROUND

“Internet of Things” (IoT) devices, for example industrial control devices, usually have vulnerabilities which can be used by attackers. Conventional information technology (IT) security measures attempt to prevent attacks as far as possible, for example by installing security patches. However, it is often not possible to promptly install security patches, in particular in industrial environments, but rather this can be carried out only in a maintenance window. In addition, manipulated or compromised IoT devices must be identified as such in order to be able to block or deactivate them. However, this may result in further effects, in particular failure or interruption of production.

Therefore, there is a need for IoT devices that are more resilient to attacks. In particular, the IoT devices are intended to be able to be operated more resiliently in terms of their core functionalities in the face of threats caused by known, unpatched vulnerabilities or a known or presumed manipulation. Unlike in the case of HTTP-based access to servers, it is often not practically possible to implement zero-trust-based access control in the case of industrial application protocols such as MQTT, OPC UA, since the application protocols used must be adapted for this purpose.

### SUMMARY

Therefore, teachings of the present disclosure include methods for operating an IoT device having applications, which is improved in comparison with the prior art. In particular, the IoT device is intended to be able to be operated more securely than previously known, and/or particularly interruption-free operation of the IoT device is intended to be possible.

For example, some embodiments include a method for operating an IoT device (IOTD) having one or more applications which process messages (MESS) according to application protocols (APPP), in which messages (MESS) for the application protocols (APPP) are received by the IoT device (IOTD), wherein a device integrity status (DT) of the device is used, and the messages (MESS) for the application protocols (APPP) are filtered on the basis of the device integrity status (DT), and the messages (MESS), after they have been filtered, are processed by the application(s) according to the application protocols (APPP).

In some embodiments, the application protocols (APPP) are not changed or are not changed or adapted on the basis of the device integrity status (DT).

In some embodiments, the IoT messages (MESS), before they are filtered for the application protocols (APPP) on the basis of the device integrity status (DT), are decrypted by means of TLS and/or DTLS and/or QUIC.

In some embodiments, the application protocols (APPP) comprise OPC UA and/or XMPP and/or MQTT.

In some embodiments, the IoT device (IOTD) is operated in an industrial network (ISYS).

In some embodiments, the IoT device (IOTD) is a manufacturing device and/or a transport device and/or a maintenance instrument and/or a logistics device.

As another example, some embodiments include an IoT device designed for operation by means of a method as described herein, which has one or more applications which process messages according to application protocols (APPP) and is designed to receive messages (MESS) for the application protocols (APPP), wherein there is a message filter (MF) for messages (MESS) which is designed to filter messages (MESS) for the application protocols (APPP) on the basis of a device integrity status (DT), wherein the message filter (MF) supplies the filtered messages (MESS) to the application(s) for processing the messages according to the application protocols (APPP).

In some embodiments, the IoT device has a decryption device which is configured to decrypt the messages (MESS), e.g. by means of TLS and/or DTLS and/or QUIC, and is configured to transmit the decrypted messages (MESS) to the message filter (MF).

In some embodiments, the IoT device comprises a manufacturing device and/or a transport device and/or a maintenance instrument and/or a logistics device.

In some embodiments, the application protocols (APPP) comprise OPC UA and/or XMPP and/or MQTT.

As another example, some embodiments include an industrial network having two or more IoT devices as described herein, in which the IoT devices (IOTD) are communicatively connected to one another.

In some embodiments, the industrial network forms a cyber-physical system.

### BRIEF DESCRIPTION OF THE DRAWINGS

The teachings of the present disclosure are explained in more detail below using an exemplary embodiment illustrated in the drawing.

The single FIGURE schematically shows a basic sketch of an example industrial IoT system incorporating teachings of the present disclosure.

### DETAILED DESCRIPTION

Some embodiments of the teachings herein include a method for operating an IoT device having applications which process messages according to application protocols, messages for the application protocols are received by the IoT device, and a device integrity status of the device is used, and the messages for the application protocols are filtered on the basis of the device integrity status, and the messages, after they have been filtered, are processed according to the application protocols. The method restricts the application protocol communication of applications of IoT devices on the basis of the current device trust. This limits the control possibilities and therefore the potential damage. Unlike what is known in the prior art, the application protocols used themselves need not be adapted for this purpose. Instead, the filtering on the basis of the device integrity status can be used to filter out the message, even before it is processed by the one or more applications. The device security is therefore considerably increased.

In other words, the methods support the aim of improved resilience of an IoT system. It is possible to achieve the situation in which, even in the case of ongoing attacks, at least limited operation of the IoT device(s) is possible, wherein the filtering on the basis of the device integrity status of the IoT device means that there is control over the potential effects of the damage. This resilience protection can be implemented in an environment protected according to a zero trust philosophy, since it is also effective during encrypted communication. It can also be implemented in an industrial IoT environment in which established application protocols, in particular control protocols, which cannot be easily expanded or adapted are used.

The device integrity information may be formed by using information relating to the software components of the IoT device and using information relating to vulnerabilities of these software components. On account of known vulnerabilities of the software components being assigned to those software components which are actually implemented in and/or at and/or on the IoT device, device integrity information can be calculated on the basis of the vulnerabilities of the software components. In particular, the consideration of the software components actually used makes it possible to assess the device integrity information in a particularly reliable manner and therefore makes it possible to implement the method according to the invention in a particularly effective manner.

The messages, before they are filtered for the application protocols on the basis of the device integrity status, are decrypted, e.g. by means of TLS and/or DTLS and/or QUIC. In some embodiments, the method is compatible with typical IoT device environments in which encrypted communication is regularly or always used. On account of messages being filtered after they have been decrypted and before they are processed by the application protocols of the one or more applications, the method according to the invention can be used in a versatile manner and in a manner compatible with previously used methods.

In some embodiments, the application protocols comprise OPC UA and/or XMPP and/or MQTT. These application protocols in particular can be adapted with difficulty or not usefully at all in production environments.

In some embodiments, the IoT device is operated in an industrial network. In industrial networks in particular, failure of the IoT device would be disadvantageous on account of the associated productivity losses. On the one hand, a failure time of IoT devices can be kept considerably low and, at the same time, the security when using the IoT device can be kept high.

In some embodiments, the IoT device is a manufacturing device and/or a transport device and/or a maintenance instrument and/or a logistics device. The aforementioned applications in particular regularly require the use of IoT devices with a high rate of exchanged messages.

An IoT device incorporating teachings of the present disclosure is designed to be operated by means of one or more of the methods incorporating the teachings herein. The IoT device has applications which process messages according to application protocols and the IoT device is designed to receive messages for the application protocols, wherein there is a message filter for messages which is designed to filter messages for the application protocols on the basis of a device integrity status, wherein the message filter supplies the filtered messages to the applications for processing the messages according to the application protocols. Therefore, the same advantages as already explained in more detail for the methods arise for the IoT devices.

In some embodiments, the IoT device has a decryption device which is configured to decrypt the messages, e.g. by means of TLS and/or DTLS and/or QUIC, and which is configured to transmit the decrypted messages to the message filter.

In some embodiments, the IoT device is a manufacturing device and/or a transport device and/or a maintenance instrument and/or a logistics device. In some embodiments, the IoT device forms a cyber-physical device.

In some embodiments, the application protocols comprise OPC UA and/or XMPP and/or MQTT.

An example industrial network incorporating teachings of the present disclosure has two or more IoT devices communicatively connected to one another.

In some embodiments, the industrial network forms a cyber-physical system.

The single figure schematically shows a basic sketch of an example industrial IoT system ISYS incorporating teachings of the present disclosure. The IoT system ISYS is a manufacturing system.

In further exemplary embodiments which are not specifically illustrated, the IoT system ISYS may also be a transport logistics system, for instance with autonomous vehicles, or a maintenance system or another industrial IoT system ISYS, for instance a cyber-physical system.

The industrial IT system ISYS comprises a plurality of IT devices IOTD. In the exemplary embodiment illustrated, the IoT devices IOTD are manufacturing tools, for example drilling tools. The IoT devices IOTD comprise sensors S and actuators A for interacting with the physical world PW. The sensors S are used to detect a workpiece and the actuators A are used to machine the workpiece, for example drills for drilling holes into the workpiece. These sensors S and actuators A are read and controlled by other components of the IT device IOTD in a manner known per se by means of an input/output interface IO. In addition, the IoT devices are communicatively connected to one another.

In the embodiment illustrated, application protocol communication is restricted on the basis of the current device trust DT. In this manner, control possibilities opened up by the application protocol communication are used to limit the damage potentially occurring with these control possibilities. By means of the illustrated solution, it is not necessary to adapt used application protocols APPP themselves.

In the illustrated solution, a “device resilience agent” DRA is provided on an IoT device IOTD. On the one hand, the device resilience agent DRA undertakes packet filtering of the data stream NWIF received by the IoT device IOTD in a manner known per se by means of a packet filter PF. After the packet filtering, the data stream NWIF is decrypted in an appropriate manner, in the present case by means of the encryption protocols TLS, DTLS and QUIC.

In addition, however, the IoT device IOTD also has a message filter MF for filtering the messages MESS of the application protocol APPP used. By means of this message filter MF, the decrypted data stream is not immediately used in the application protocols APPP, in the present case OPC UA and XMPP and MQTT, for example. Instead, in a restricted manner, the message filter MF filters the messages MESS specifically for each application protocol APPP used in each case and transfers the accordingly filtered messages MESS to the respective application protocol APPP for further processing.

The device communication of the IoT device IOTD therefore takes place in an encrypted manner, as is conventional with a zero trust approach. At the same time, however, on account of the filtering of the messages MESS by means of the special message filter MF, possible undesirable influence, for example damage, is avoided or limited. The resilience of the IoT device IOTD and therefore of the industrial system ISYS is therefore improved.

The device resilience agent DRA determines a device trust status DTS and adapts the filter rules of the message filter MF on the basis thereof. In addition, an IoT control function of the IoT device IOTD and/or a packet filter of the IoT device IOTD and/or an I/O interface of the IoT device IOTD can also be adapted.

The device trust DT of the IoT device IOTD can be locally determined on the IoT device IOTD, for example by means of a device integrity monitoring system on the IoT device IOTD in the form of a so-called device health check which is known per se and is carried out by a device health agent DHA. In some embodiments, the device trust DT can also be determined outside the device, by a zero trust device manager ZTDM in the illustrated example. This device manager can also use vulnerability information that is directly provided by the device manufacturer MAN of the IoT device IOTD by means of a device vulnerability database DVD or is indirectly determined by means of the “software bill of material” SBOM of the IoT device IOTD that is provided by the device manufacturer MAN and known vulnerabilities of software components used by this IoT device IOTD. These vulnerabilities of the software components can then be mapped to device vulnerabilities by means of an assignment database ZUO. The vulnerabilities of the software components can be taken, for example, from a software vulnerability database SVD. The vulnerability information relating to the IoT device IOTD that is determined indirectly in this manner can also be placed in the device vulnerability database DVD. The vulnerability information relating to the IoT device IOTD in the device vulnerability database DVD is used by the zero trust device manager ZTDM to determine the device trust DT of the IoT device IOTD. The current device trust DT can thereby be determined on the basis of the currently known vulnerabilities of the software components used. Furthermore, an integrity attestation of the IoT device IOTD or a device compliance status of a device management system can be evaluated.

In some embodiments, it is possible to use and evaluate security position information that indicates which vulnerabilities are currently actively being used and which regions or network regions are affected by this. Such information can be provided, for example, by a security monitoring system.

In a complex industrial system ISYS having a plurality or multiplicity of IoT devices IOTD, the teachings can be implemented on all IoT devices or only on a subset of the IoT devices IOTD used. The IoT devices IOTD can generally be implemented as permanently integrated components. In some embodiments, the IoT devices IOTD can be implemented as a component having a plurality of submodules, for example as a programmable logic controller having expansion modules in the form of technology modules or remote input/output modules, or as a virtualized IoT component, for example a virtualized PLC.

The components in the form of the message filter MF and the device resilience agent DRA which are provided for the resilience functionality of the IoT device IOTD are implemented, for example, in a protected, trusted execution environment, in an ARM trust zone in the exemplary embodiment illustrated. In some embodiments, the protected, trusted execution environment can also be implemented as a separate resilience processor module or as an FPGA or as an ASIC.

In some embodiments, the implementation is specifically protected against attack, for example by using exploit protection technologies such as ASLR or stack protection or memory encryption or control flow integrity or a combination of such exploit protection technologies. As a result, this special resilience functionality is difficult to attack or cannot be attacked and is therefore trusted, even if the general device functionality of the IoT device IOTD, for example a network stack or a control function CF of the IoT device IOTD, has already been compromised.

In some embodiments, operators of an industrial system ISYS specify which actions are allowed under which security levels. This is intended to enable predefined actions or functionalities of the IoT device IOTD to be restricted on account of the current threat situation.

What is claimed is:

1. A method for operating an IoT device having one or more applications which process messages according to application protocols, the method comprising:
receiving messages for the application protocols at the IoT device;
sampling a device integrity status of the IoT device; and
filtering the messages for the application protocols on the basis of the device integrity status; and
after filtering the messages, processing the messages, by the applications according to the application protocols.

2. The method as claimed in claim 1, wherein the application protocols are not changed on the basis of the device integrity status.

3. The method as claimed in claim 1, further comprising decrypting the IoT messages before they are filtered for the application protocols.

4. The method as claimed in claim 1, wherein the application protocols comprise OPC UA, XMPP, and/or MQTT.

5. The method as claimed in claim 1, wherein the IoT device is operated in an industrial network.

6. The method as claimed in claim 1, wherein the IoT device comprises a manufacturing device, a transport device, a maintenance instrument, and/or a logistics device.

7-12. (canceled)
